(19) United States
(12) Patent Application Publication
(10) Pub. No.: US 2017/0038052 A1
(43) Pub. Date: Feb. 9, 2017

(54) LED LIGHT FIXTURE WHICH IS CONFIGURED TO ALLOW FOR VENTING YET PREVENT INSECTS FROM ENTERING THE FIXTURE

(71) Applicant: TADD, LLC, Cary, IL (US)

(72) Inventors: Timothy Taylor, Barrington, IL (US); Tony Chang, Treasure Island, FL (US)

(21) Appl. No.: 14/818,522

(22) Filed: Aug. 5, 2015

(51) Int. Cl. F21V 29/67; F21K 99/00; F21V 15/02; F21V 5/04; F21V 23/00

(52) U.S. Cl. CPC F21V 29/673; F21V 5/04; F21V 23/003; F21V 15/02; F21K 9/1355; F21Y 2101/02

(57) ABSTRACT

An LED light fixture which includes apertures which provide for venting of the LED light fixture, but where the LED light fixture is configured to prevent insects from entering the apertures. Specifically, a screen may cover one or more apertures, and one or more other apertures may be provided as being conically-shaped. The conical shaped provides that insects are effectively prevented from entering, and also provides that a venturi effect is provided by the air flow. The pressure drops as the air travels through the conically-shaped aperture, but the speed at which the air travels increases, thereby providing for enhanced venting of the LED light fixture and providing for the increased blowing of insects away.

### BACKGROUND

The present invention generally relates to a light emitting diode (“LED”) light fixture which is configured to allow for venting of air from the LED light fixture, yet prevent insects from entering the LED light fixture.

LED light fixtures are common. LED light fixtures naturally, merely by their operation, generate heat inside the LED light fixture. Most LED light fixtures have apertures or the like for allowing air to escape from the LED light fixture, thereby allowing the LED light fixture to vent. In other words, ambient air can flow into the fixture while allowing heated air (i.e., air inside the LED light fixture which has been naturally heated as a result of operation of the LED light fixture) to flow out of the LED light fixture. Many LED light fixtures include a fan inside the LED light fixture for pulling cool air into the fixture, and blowing warm air out of the fixture, in order to cool internal circuitry as well as possibly the LED's inside the LED light fixture.

Many types of insects, including very small insects, are attracted to light. As such, it is common for insects to enter the apertures in an LED light fixture, get caught inside the LED light fixture, and parish inside the LED light fixture. If a fan is disposed inside the LED light fixture, the fan can even effectively work to pull insects into the LED light fixture. It can be detrimental to have insects flying around inside an LED light fixture, or to have dead insects collect in an LED light fixture. The insects can inhibit proper venting of the LED light fixture, can damage the circuitry or the LED's inside the LED light fixture, and/or can adversely affect performance and/or power consumption of the LED light fixture.

### SUMMARY

An object of an embodiment of the present invention is to provide an LED light fixture which includes apertures which provide for venting of the LED light fixture, but where the LED light fixture is configured to prevent insects from entering the apertures.

An object of an embodiment of the present invention is to provide an LED light fixture which includes at least one aperture which provides for air flow in and/or out of the fixture, and which includes a screen over the at least one aperture. The screen works to prevent insects from entering the at least one aperture which the screen covers.

Another object of an embodiment of the present invention is to provide an LED light fixture which includes LED's and a lens covering the LED's. The lens includes at least one aperture which provides for air flow in and/or out of the fixture. The at least aperture is conical in shape, having an opening which is smaller on the external surface of the lens that its opposite opening on an internal surface of the lens. The fact that the at least one aperture on the lens is conically-shaped provides that insects are effectively prevented from entering the lens, yet provides that the LED light fixture can not only vent through the lens, but also provides that a venturi effect is provided by the air flow through the at least one aperture. Specifically, the pressure drops as the air travels through the at least one conically-shaped aperture, but the speed at which the air travels increases, thereby providing for enhanced venting of the LED light fixture and providing for the increased blowing of insects away from the lens.

Briefly, a specific, preferred embodiment of the present invention provides an LED light fixture which includes one or both of the features identified above (i.e., a screen covering at least one aperture and/or at least one conically-shaped aperture on the fixture, such as on a lens thereof, to provide a venturi effect type of air flow therethrough).

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1A is a perspective view of an LED light fixture which is in accordance with a preferred embodiment of the present invention;

FIG. 1B is an enlarged view of a portion of that which is shown in FIG. 1A;

FIG. 2A is a top view of the LED light fixture which is shown in FIG. 1A;

FIG. 2B is an enlarged view of a portion of that which is shown in FIG. 2A; and

FIG. 3 is a simple block diagram which generally identifies the internal components of the LED light fixture shown in FIG. 1A.

### DESCRIPTION OF ILLUSTRATED EMBODIMENT

While this invention may be susceptible to embodiment in different forms, there is shown in the drawings and will be described herein in detail, a specific embodiment with the understanding that the present disclosure is to be considered an exemplification of the principles of the invention, and is not intended to limit the invention to that as illustrated.

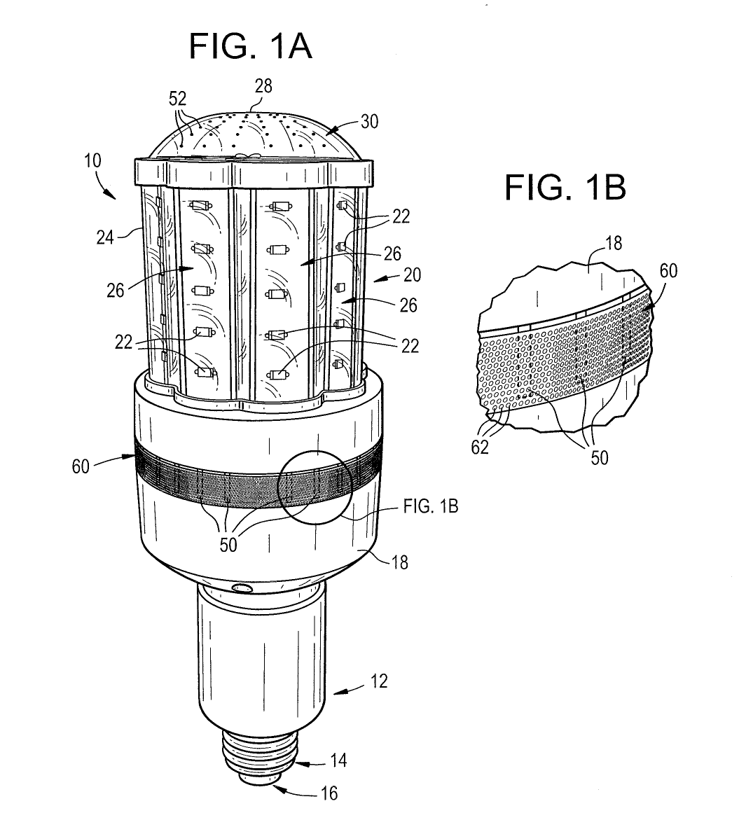

FIG. 1A is a perspective view of an LED light fixture 10 which is in accordance with a preferred embodiment of the present invention. As shown, the LED light fixture 10 preferably includes a base 12 which has an electrical connector 14 at its end 16, where the electrical connector 14 is configured to electrically engage a light socket which powers the LED light fixture 10.

As shown in FIG. 1A, the LED light fixture 10 also preferably includes a housing 18 which is connected to the base 12, and an LED light tower 20 is connected to the housing 18. The LED light tower 20 preferably includes a plurality of LED's 22 which emit light, and which are covered by at least one lens 24.

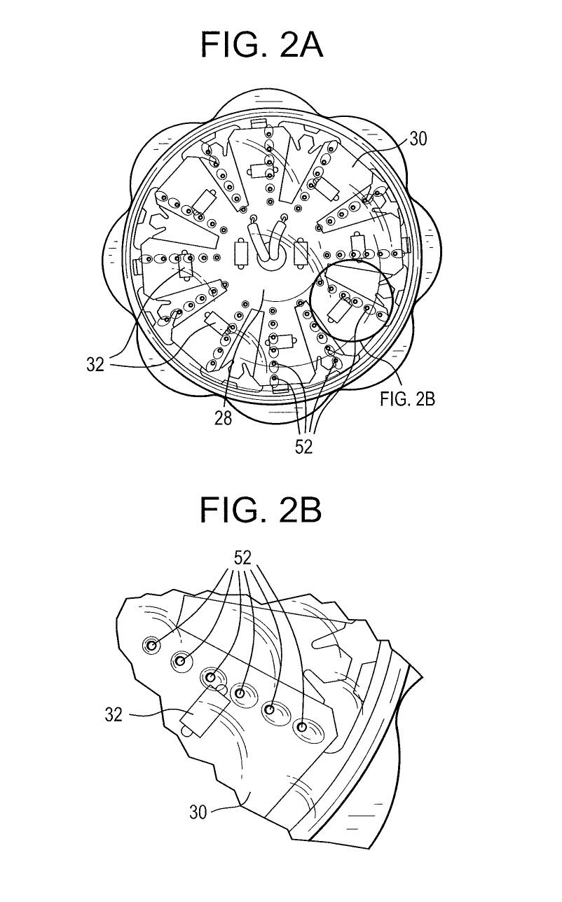

As shown, the LED's 22 in the LED light tower 20 may be provided in a plurality of spaced-apart columns 26 which are arranged parallel to each other. Preferably, these columns 26 of LED's 22 are covered by one or more lenses, such as a single lens 24 which effectively defines the external surface of the LED light tower 20. Preferably, at the top 28 of the LED light fixture 10 is a lens 30 which covers an additional set of LED's 32 which is disposed inside the LED light fixture 10. These LED's 32 can best be seen in FIG. 2A, which provides a top view of the LED light fixture 10, and shows the lens 30 which covers these LED's 32.

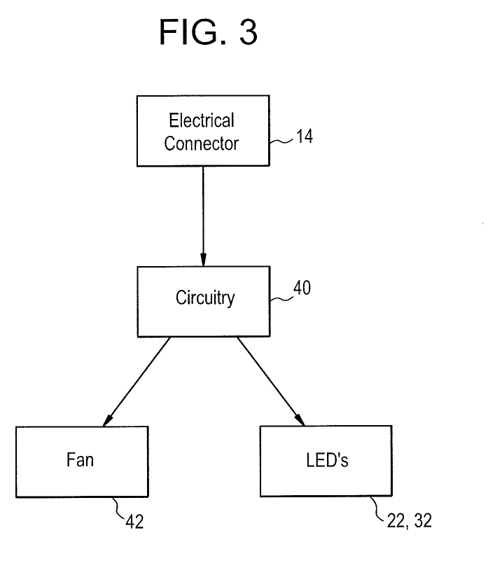

Inside the LED light fixture 10, there are electrical components some of which are shown in the block diagram provided in FIG. 3. As shown, the LED light fixture 10 may include circuitry 40 which is powered by the light socket via the electrical connector 14 at the end 16 of the LED light fixture 10. This circuitry 40 not only drives the LED's 22, 32 of the LED light fixture 10, but also preferably drives a fan 42 which is located inside the LED light fixture 10. The fan 42 functions to keep the inside of the LED light fixture 10 cooler than it otherwise would be. More specifically, the fan 42 pulls ambient air inside the LED light fixture 10 through at least one aperture 50, and blows heated air out the LED light fixture 10 through at least one other aperture 52. Those apertures 50, 52 will now be described.

As shown in FIG. 1A, the LED light fixture preferably includes a first set of apertures 50 spaced around the perimeter of the housing 18. FIG. 1B is an enlarged view of a portion of that which is shown in FIG. 1A. As shown in FIGS. 1A and 1B, these apertures 50 which are provided on the housing 18 may take the form of rectangular slits. However, other shapes are entirely possible.

As shown in FIG. 2A, the lens 30 on the top 28 of the LED light fixture 10 preferably includes a second set of apertures 52. Preferably, the fan 42 is configured to pull ambient air in through the first set of apertures 50 which are provided in the housing 18, and blow heated air out the second set of apertures 52 which are provided in the lens 30. However, the fan 42 can very well be configured to work in the opposite direction (i.e., pull ambient air in through the apertures 52 which are provided in the lens 30, and blow heated air out the apertures 50 which are provided in the housing 18). It should be noted again that when the air is indicated as being “heated,” what is meant is that the air has been naturally heated via operation of the LED's, 22, 32, the circuitry 40 in the LED light fixture 10, or both.

Preferably, both set of apertures 50, 52 are configured to prevent insects from entering the LED light fixture 10. To that end, as shown in FIG. 1A, preferably the apertures 50 which are provided on the housing 18 are covered with a screen 60. FIG. 1B provides an enlarged view of a portion of that which is shown in FIG. 1A. As shown in FIG. 1B, the screen 60 preferably has apertures or openings 62 which are substantially smaller than the apertures 50 on the housing 18 which the screen 60 covers. As such, air is allowed to travel through the screen 60 and apertures 50, but insects are prohibited by the screen 60 from entering the LED light fixture 10 through the apertures 50.

With regard to the apertures 52 which are provided on the top 28 of the LED light fixture 10 (i.e., on the lens 30 at the top 28 of the LED light fixture 10), preferably those apertures 52 are provided as being conically-shaped. This can be seen best in FIG. 2B which shows an enlarged view of a portion of that which is shown in FIG. 2A. As shown in FIG. 2B, the apertures 52 are preferably conical in that each has an opening which is smaller on the external surface of the lens 30 than its opposite opening on an internal surface of the lens 30 (i.e., pointing toward the LED's 32). The fact that the apertures 52 in the lens 30 are conically-shaped provides that insects are prevented from entering the lens 30 through the apertures 52, yet provides that the LED light fixture 10 can not only vent air through the lens 30, but also that a venturi effect is provided by the air flow through the apertures 52 in the lens 30. Specifically, the pressure drops as the air travels through the conically-shaped apertures (i.e., from the LED's 32 out the lens 30), but the speed at which the air travels through the apertures 52 increases, thereby providing for enhanced venting of the LED light fixture 10 and providing for the increased blowing of insects away from the lens 30.

While a specific embodiment of the invention has been shown and described, it is envisioned that those skilled in the art may devise various modifications without departing from the spirit and scope of the present invention. For example, the apertures on the housing covered by the screen could very well be conically-shaped as well, or a screen can be employed to cover the apertures in the lens as well. Still other alternatives are entirely possible.

What is claimed is:

1. An LED light fixture comprising at least one aperture thereon, said aperture being at least one of conically-shaped and covered by a screen.

2. The LED light fixture as recited in claim 1, wherein the LED light fixture comprises a housing, and said screen is disposed on the housing over said aperture.

3. The LED light fixture as recited in claim 1, wherein the LED light fixture comprises a lens, and wherein said conically-shaped aperture is disposed on the lens.

4. The LED light fixture as recited in claim 1, wherein said at least aperture comprises a first set of apertures and a second set of apertures, wherein the LED light fixture comprises a housing and a lens, wherein the first set of apertures are on the housing, and said second set of apertures are on said lens, said screen being disposed on the housing over said first set of apertures, wherein said second set of apertures on the lens are conically-shaped.

5. The LED light fixture as recited in claim 3, further comprising LED's, said LED's being covered by the lens.

6. The LED light fixture as recited in claim 4, further comprising LED's, said LED's being covered by the lens.

7. The LED light fixture as recited in claim 4, wherein the first set of apertures comprise rectangular slits, and said screen has apertures which are smaller than the slits.

8. The LED light fixture as recited in claim 1, wherein the LED light fixture comprises a base having an end which is configured to electrically connect to a light socket.

9. The LED light fixture as recited in claim 1, wherein said at least aperture comprises a first set of apertures and a second set of apertures, wherein the LED light fixture comprises a housing and a lens, wherein the first set of apertures are on the housing, and said second set of apertures are on said lens, said screen being disposed on the housing over said first set of apertures.

10. The LED light fixture as recited in claim 3, wherein the lens is at an end of the LED light fixture.

11. The LED light fixture as recited in claim 1, wherein the LED light fixture further comprises a fan, LED's, and circuitry which drives both the fan and the LED's.

12. The LED light fixture as recited in claim 1, wherein said at least aperture comprises a first set of apertures and a second set of apertures, wherein the fan pulls air in the first set of apertures and blows air out the second set of apertures.

13. The LED light fixture as recited in claim 12, wherein the LED light fixture comprises a housing and a lens, wherein the first set of apertures are on the housing, and said second set of apertures are on said lens.

14. The LED light fixture as recited in claim 13, wherein said screen is disposed on the housing over said first set of apertures.

15. The LED light fixture as recited in claim 13, wherein said second set of apertures on the lens are conically-shaped.

16. The LED light fixture as recited in claim 13, wherein said screen is disposed on the housing over said first set of apertures, and wherein said second set of apertures on the lens are conically-shaped.
